(19) United States
(12) Patent Application Publication
(10) Pub. No.: US 2008/0235979 A1
(43) Pub. Date: Oct. 2, 2008

(54) Hi-N-Dri

(76) Inventor: Michael D. Meecham, Cullompton (GB)

Correspondence Address: Raymond M. Galasso;Galasso & Associates LP, P.O. Box 26503, Austin, TX, 78755-0503, US

(21) Appl. No.: 11/729,155

(22) Filed: Mar. 27, 2007

(51) Int. Cl. F26B 19/00

(52) U.S. Cl. 34/86; 135/33.2

(57) ABSTRACT

The preferred embodiment of Hi-N-Dri is a cover that conforms to the shape of traditional roto dryers and has fastening mechanisms and a central tube for attachment to the supporting structure and central pole of a roto dryer. To use Hi-N-Dri, an individual would place the cover over the outdoor dryer, lining up the central pole of the outdoor dryer with the adjustable tube in the center of the cover. The user then adjusts the center tube to fit the selected outdoor clothes dryer. Then, the user winds the velcro hook and loop strap around the supporting structure of the outdoor dryer in each corner to more firmly attach the cover to the outdoor dryer. Clothes can then be hung on the clotheslines of the outdoor dryer in the traditional manner.

### CROSS REFERENCE TO RELATED APPLICATIONS

This U.S. Non-Provisional Patent Application does not claim priority to any U.S. Provisional Patent applications or any foreign patent applications.

### FIELD OF THE DISCLOSURE

The disclosures made herein relate generally to the clothing care industry. The invention discussed herein is in the general classification of outside clothes dryer covers.

### BACKGROUND

Clothing serves a variety of functions. Some people view clothing in purely a utilitarian manner. These individuals believe clothing serves as a form of protection against the elements such as sun, rain or cold. For other people, clothing is a fashion statement. These types of people often choose their clothes based on what is being modeled on the runways or what the famous actors and actresses are wearing. Some individuals choose clothes to make a statement of their independence. These people choose clothes that are contrary to the latest trends in an effort to be unique.

Regardless, all clothing must be washed. Many people must run two loads of laundry in an average week. The more people in a family, the higher the number of loads of laundry required. Many people find themselves doing laundry almost everyday, especially if they have small children. Towels, sheets and other linens also add volume to the laundry and require additional care.

Before the invention of electricity, washing laundry was a difficult task. People would wash clothes by hand using a washtub and a scrubbing board. The clothes would then have to be hung outside to dry. Almost all clothing needed to be ironed after drying. This method of cleaning clothes and other items was time consuming and inefficient.

In more modern times, electric powered washers and electric or gas powered dryers have made this task a lot easier. A load of laundry can be washed and dried in just a couple of hours with the machines doing the majority of the work.

Despite the availability of clothes dryers, many individuals still prefer to hang their laundry outside to dry. Some do this to avoid shrinkage of clothing that may occur from use of electric or gas powered dryers. Others simple prefer the clean, fresh scent that can only be achieved when clothes are hung on a clothesline or other outdoor dryer. Still others prefer not having the dryer heat up the house and enjoy the energy savings of not running a clothes dryer. It is often quicker to hang laundry out to dry because the sun and wind can dry items faster than any electric clothes dryer.

The main drawback to hanging clothes outside to dry is that the clothing becomes vulnerable to the elements. An unanticipated rainstorm will prevent clothes from drying properly. Birds or other animals also can create a variety of problems with drying clothing outdoors.

Outdoor dryers or roto dryers are umbrella type outdoor drying units that extend clothes lines off of one central pole. These have become popular because they provide a large amount of drying surface area without having to string a clothesline over an extended distance. Unfortunately, these outdoor dryers are still vulnerable to the elements.

Hence, there is a need in the art for an aesthetically pleasing, effective, affordable and convenient device to cover an outdoor clothes dryer.

### SUMMARY OF THE DISCLOSURE

Hi-N-Dri is an adjustable cover for outdoor clothes dryers.

The principal object of this invention is to provide a device to cover outdoor clothes dryers.

Another object of this invention is to provide an affordable device to cover outdoor clothes dryers.

Another object of this invention is to provide an adjustable device to cover different size outdoor clothes dryers.

Another object of this invention is to provide an aesthetically pleasing device to cover outdoor clothes dryers.

Another object of this invention is to provide an easy to install and use device to cover outdoor clothes dryers.

### BRIEF DESCRIPTION OF THE DRAWINGS

FIG. 1 depicts a perspective view of the preferred embodiment of the invention.

FIG. 2 depicts a frontal view of the preferred embodiment of the invention as it is being placed on a roto/outdoor clothes dryer.

### DETAILED DESCRIPTION OF THE DRAWINGS

The preferred embodiment of Hi-N-Dri is a cover that conforms to the shape of traditional roto dryers and has fastening mechanisms and a central tube for attachment to the supporting structure and central pole of a roto dryer.

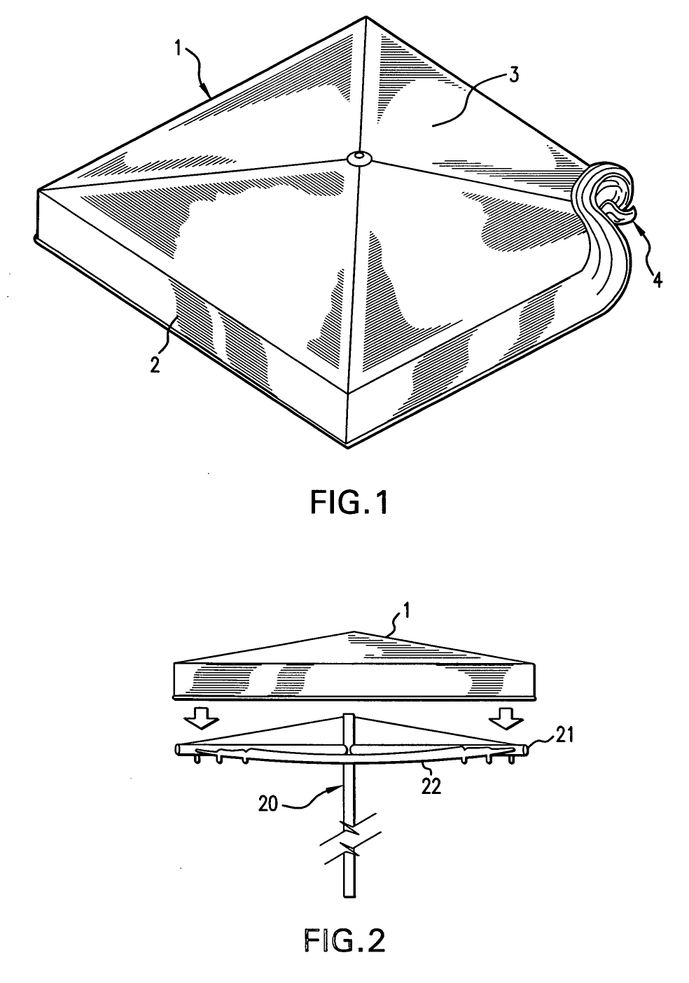

FIG. 1 depicts the preferred embodiment of the invention. A cover 1 made of nylon is approximately two meters in length and two meters in width. Though other materials could also be used, nylon was selected for the cover 1 because it is one of the strongest materials on the market and often is waterproof to provide protection to the laundry beneath the cover 1. The sides 2 of the cover 1 descend approximately two hundred millimeters from the top 3 of the cover 1 to provide added protection. Obviously, the size and shape of the cover and sides can be customized to fit almost any outdoor dryer.

The top 3 of the cover 1 has a set of four braces (not pictured) that extend from each corner of the cover 1 to the inside, center of the cover 1. These braces are slightly angled to give the top 3 of the cover 1 a pyramid shape that will fit over conventional roto dryers. The braces provide strength and structural support for the cover 1 and would ideally be made of stainless steel. A velcro hook and loop strap 4 is located in each corner of the cover 1 and is used as an attaching mechanism to the roto dryer. An adjustable tube (not pictured) is located in the center and underneath the cover 1. The tube is ideally made of plastic to provide durability and corrosion resistance. The tube is adjustable so that it can fit a variety of roto dryers with different dimensioned central poles.

FIG. 2 depicts the preferred embodiment of the invention as it is being placed on an outdoor clothes dryer/roto dryer. The central pole 20, supporting structure 21 and clothes line 22 of the roto dryer can be seen in detail in this figure. The cover 1 can be placed directly over the roto dryer to protect any clothes hung on the clothes line 22.

To use Hi-N-Dri, an individual would place the cover over the outdoor dryer, lining up the central pole of the outdoor dryer with the adjustable tube in the center of the cover. The user then adjusts the center tube to fit the selected outdoor clothes dryer. Then, the user winds the velcro hook and loop strap around the supporting structure of the outdoor dryer in each corner to more firmly attach the cover to the outdoor dryer. Clothes can then be hung on the clotheslines of the outdoor dryer in the traditional manner without worrying about an unexpected snow or rain storm.

The materials used to construct Hi-N-Dri may vary widely but will likely include plastic, metal, textiles, velcro and other components.

The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Hi-N-Dri can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the cover of the present invention can be of various shapes and sizes. It should also be obvious that the components of the invention can be made of different types of plastics or other suitable materials and can be of any color. The velcro hook and loop attaching mechanism utilized in the preferred embodiment could be replaced with alternative attaching mechanisms. For example, a hook and loop or a strap with a button and hole could be utilized. Other attaching mechanisms well known in the art are also available.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A device for use with outdoor clothes dryers comprising:
(a) a cover;
(b) an attaching mechanism on the perimeter of the cover; and
(c) a tube located in approximately the center of the cover and attached beneath the cover.

2. The device of claim 1 wherein the cover is made of nylon.

3. The device of claim 1 wherein the cover is approximately square.

4. The device of claim 3 further comprising
a set of four sides that descend from the top of the cover.

5. The device of claim 1 wherein the cover is made of a waterproof material.

6. The device of claim 3 further comprising
a set of four braces extending from each corner of the cover to the center of the cover.

7. The device of claim 6 wherein the set of four braces is made of stainless steel.

8. The device of claim 6 wherein the set of four braces are angled descending from the center of the cover to each corner to create a pyramid.

9. The device of claim 1 wherein the tube is made of plastic.

10. The device of claim 1 wherein the tube is adjustable.

11. The device of claim 1 wherein the attaching mechanism is a velcro hook and loop strap.

12. The device of claim 1 wherein the attaching mechanism is a button hole and button strap.

13. A device for use with outdoor clothes dryers comprising:
(a) a cover that is approximately square and made of nylon;
(b) a plurality of velcro hook and loop straps located on each corner of the cover;
(c) a tube that is adjustable and made of plastic in approximately the center of the cover and attached beneath the cover;
(d) a set of four sides that descend from the top of the cover; and
(e) a set of four braces extending from each corner of the cover to the center of the cover wherein the set of four braces are made of stainless steel and are angled descending from the center of the cover to each corner of the cover to create a pyramid.
